(19) United States
(12) Patent Application Publication
(10) Pub. No.: US 2020/0115663 A1
(43) Pub. Date: Apr. 16, 2020

(54) BEVERAGE COMPOSITIONS AND METHODS OF MAKING AND USING THE SAME

(71) Applicant: Golden Spice Liquors LLC, Salt Lake City, UT (US)

(72) Inventor: John Earl Worthen, Salt Lake City, UT (US)

(21) Appl. No.: 16/598,246

(22) Filed: Oct. 10, 2019

Related U.S. Application Data
(60) Provisional application No. 62/869,931, filed on Jul. 2, 2019.
(60) Provisional application No. 62/845,106, filed on May 8, 2019.
(60) Provisional application No. 62/738,975, filed on Oct. 16, 2018.

(51) Int. Cl. C12G 3/06; C12G 3/05; A23L 29/00; A23L 33/105

(52) U.S. Cl. CPC C12G 3/06; C12G 3/05; A23L 33/105; A23L 29/045; A23L 29/035

(57) ABSTRACT

Described herein are beverage compositions that include a compound having increased solubility and increased bioavailability. Specifically, the beverage composition may include turmeric or a component or compound derived from turmeric, with increased solubility and bioavailability of turmeric or turmeric-derived components and compounds. Also provided are methods of making and using the beverage compositions.

### RELATED APPLICATIONS

This application claims the benefit of priority to U.S. Provisional Patent Application Nos. 62/738,975, filed Oct. 16, 2018, 62/845,106, filed May 8, 2019, and 62/869,931, filed Jul. 2, 2019, the disclosure of each of which is incorporated by reference herein in its entirety.

### FIELD

The present disclosure relates to beverage compositions and methods of making and using the same. In particular, the present disclosure relates to beverage compositions, such as alcohol beverages having increased bioavailability of beneficial compounds that typically have low solubility and low bioavailability. Also provided are methods of making and using the beverage compositions.

### BACKGROUND

Turmeric is derived from the rhizomes of Curcuma longa, which is a member of the ginger family (Zingiberaceae). A major bioactive component of turmeric includes curcuminoids, which are polyphenolic compounds that give turmeric its yellow color. Curcumin, a bioactive species having the Formula (1), is the principal and prototype curcuminoid.

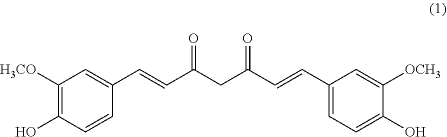 [SMILES: COc1cc(/C=C/C(=O)CC(=O)/C=C/c2ccc(O)c(OC)c2)ccc1O]

Ground turmeric is used as a seasoning and is the main ingredient in curry. Turmeric has been used in the practice of medicine since 1900 B.C., and in many parts of the world, it is still used as an alternative medicinal agent for the treatment of a variety of ailments such as stomach ache, flatulence, jaundice, arthritis, sprains, wounds, and skin infections. Curcumin, chemically known as diferuloylmethane, is recognized as the primary biologically active curcuminoid and was first isolated from turmeric almost two centuries ago. Curcumin has recently gained attention as an immune system contributor, with beneficial effects reported in treating arthritis, allergy, asthma, atherosclerosis, heart disease, Alzheimer's disease, cancer, and diabetes.

Turmeric, and its principal bioactive components generally exhibit low bioavailability and low solubility. Thus, despite the potential for therapeutic benefits of these compounds, subjects ingesting the compounds do not realize the full potential due to the poor bioavailability.

### SUMMARY

Accordingly, the present disclosure relates to beverage compositions having increased bioavailability of compounds that typically have low bioavailability in aqueous solution, in particular turmeric and turmeric derived compounds in combination with other low solubility or low bioavailable compounds.

Some embodiments provided herein relate to beverage compositions that include one or more components or compounds derived from turmeric, an alkaloid, citric juice, and a sweetener. In some embodiments, the beverage is an alcoholic beverage. In some embodiments, the alcoholic beverage is beer, ale, spirit, wine, sherry, brandy, liqueurs, port, vodka, gin, whisky, scotch, absinthe, cognac, tequila, rum, ouzo, sake, or champagne, or combinations thereof. In some embodiments, the one or more compounds or components derived from turmeric include curcumin, curcumene, demethoxycurcumin, bisdemethoxycurcumin, turmerone, germacrone, atlantone, curlone, curdione, zedeorone, or zingiberene, or a combination thereof. In some embodiments, the one or more compounds derived from turmeric are derived from a turmeric rhizome. In some embodiments, the alkaloid is piperine. In some embodiments, the piperine is derived from peppercorn. In some embodiments, the citric juice is lime juice, lemon juice, orange juice, tangerine juice, grapefruit juice, or a combination thereof. In some embodiments, the sweetener includes honey. In some embodiments, the one or more compounds or components derived from turmeric is present in an amount of about 0.001 mg/ml to about 10 mg/ml. In some embodiments, the alkaloid is present in an amount of about 0.001% w/v to about 10% w/v. In some embodiments, the citric juice is present in an amount of 0.1% w/v to about 10% w/v. In some embodiments, the sweetener is present in an amount of 0.001% w/v to about 25% w/v. In some embodiments, the composition includes curcumin present in an amount of about 0.001 mg/ml to about 10 mg/ml. In some embodiments, the composition includes turmerone present in an amount of about 0.001 mg/ml to about 10 mg/ml. In some embodiments, the composition includes peppercorn present in an amount of about 0.001% w/v to about 10% w/v. In some embodiments, the composition includes lime or orange juice present in an amount of about 0.1% w/v to about 10% w/v. In some embodiments, the composition includes honey present in an amount of 0.001% w/v to about 25% w/v. In some embodiments, the composition exhibits elevated bioavailability of the one or more compounds or components derived from turmeric.

Some embodiments provided herein relate to methods of making a beverage composition. In some embodiments, the methods include providing a turmeric rhizome, extracting one or more compounds from the turmeric rhizome, and adding the extracted one or more compounds from the turmeric rhizome to a solution. In some embodiments, extracting includes a physical or a chemical extraction process, or a combination thereof. In some embodiments, extracting comprises grinding, milling, crunching, cutting, chopping, grating, pulverizing, blending, mixing, pressing, crushing, pressurizing, boiling, or steaming the turmeric rhizome, or a combination thereof. In some embodiments, the solution is an alcohol solution. In some embodiments, the methods further include adding an alkaloid. In some embodiments, the alkaloid is piperine. In some embodiments, the methods further include maintaining a pH of the solution at a pH ranging from about 2 to about 7.

Some embodiments provide herein relate to methods of increasing bioavailability of turmeric or a component or compound derived therefrom. In some embodiments, the methods include mixing turmeric or a component or compound derived therefrom in a solution, mixing the solution with a bioavailability enhancing compound, and administering the solution to a subject. In some embodiments, intake of turmeric or a component or compound derived therefrom is increased. In some embodiments, the component or compound derived from turmeric includes curcumin, curcumene, demethoxycurcumin, bisdemethoxycurcumin, turmerone, germacrone, atlantone, curlone, curdione, zedeorone, or zingiberene, or a combination thereof. In some embodiments, the solution exhibits enhanced bioavailability of turmeric or the component or compound derived therefrom. In some embodiments, the bioavailability enhancing compound includes quercetin, resveratrol, silibinin, curcumin, piperine, gingerol, allicin, glycyrrhizin, genistein, sinomenine, Stevia rebaudiana, Aloe vera, lysergol, Carum carvi, niaziridin, capsaicin, naringin, Zingiber officinalte, Ammannia multiflora, capul, cow urine distillate, essential oils, honey vegetable glycerin, omega-3 fish oil, flax seed oil, olive oil, canola oil, soybean oil, sunflower oil, a terpene, a cannabinoid, such as cannabidiol, or helichrysum italicum oil. In some embodiments, the solution is an alcohol solution. In some embodiments, the methods further include increasing total turmeric or component or compound derived therefrom in the subject. In some embodiments, the subject's turmeric or component or compound derived therefrom is increased in an amount ranging from 10% to 500%.

### DETAILED DESCRIPTION

Embodiments provided herein relate to beverage compositions having increased bioavailability of compounds that typically exhibit low bioavailability, or that have a generally low solubility. Also provided are methods of making and using the compositions.

It will be readily understood that the aspects of the present disclosure, as generally described herein, can be arranged, substituted, combined, separated, and designed in a wide variety of different configurations, all of which are explicitly contemplated herein.

Unless defined otherwise, technical and scientific terms used herein have the same meaning as commonly understood by one of ordinary skill in the art to which the present disclosure belongs. All patents, applications, published applications and other publications referenced herein are expressly incorporated by reference in their entireties unless stated otherwise. For purposes of the present disclosure, the following terms are defined below.

The articles “a” and “an” are used herein to refer to one or to more than one (for example, at least one) of the grammatical object of the article. By way of example, “an element” means one element or more than one element.

By “about” is meant a quantity, level, value, number, frequency, percentage, dimension, size, amount, weight or length that varies by as much as 30, 25, 20, 15, 10, 9, 8, 7, 6, 5, 4, 3, 2 or 1% to a reference quantity, level, value, number, frequency, percentage, dimension, size, amount, weight or length.

Throughout this specification, unless the context requires otherwise, the words “comprise,” “comprises,” and “comprising” will be understood to imply the inclusion of a stated step or element or group of steps or elements but not the exclusion of any other step or element or group of steps or elements.

By “consisting of” is meant including, and limited to, whatever follows the phrase “consisting of” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

In some embodiments, the “purity” of any given agent (e.g., antibody, polypeptide binding agent) in a composition may be specifically defined. For instance, certain compositions may comprise an agent that is at least 80, 85, 90, 91, 92, 93, 94, 95, 96, 97, 98, 99, or 100% pure, including all decimals in between, as measured, for example and by no means limiting, by high pressure liquid chromatography (HPLC), a well-known form of column chromatography used frequently in biochemistry and analytical chemistry to separate, identify, and quantify compounds.

The term “isolated” is meant material that is substantially or essentially free from components that normally accompany it in its native state. For example, an “isolated compound,” as used herein, includes a compound that has been purified from the mixture of compounds or the parent composition from which the compound is derived in its naturally-occurring state.

### Compositions

Some embodiments provided herein relate to beverage compositions. As used herein, the term “composition” or “formulation” as used herein refers to a combination of elements, components, or compositions presented together for a given purpose. As used herein, the term “beverage” refers to a liquid substance intended for drinking. Thus, beverage refers to a liquid that is ready for consumption, as well as a liquid that will undergo other processes or treatments, such as filtering or the addition of flavorings, colorants, sweeteners, another beverage, etc., before being consumed.

In some embodiments, the beverage composition is an alcoholic beverage composition. In some embodiments, the beverage composition includes turmeric, quercetin, resveratrol, or a combination thereof.

The term “turmeric,” as used herein, may be used to refer either to the plant Curcuma longa or the spice derived from the rhizomes of the plant. In some embodiments, the beverage composition include turmeric or a component or compound derived therefrom. Over 235 components or compounds have been isolated from turmeric. Components and compounds that are found in turmeric and that may be included in the composition include, for example, various curcuminoids and various essential oils. In some embodiments, the beverage compositions include curcumin, tumerone, and at least one of the more than 235 compounds found in turmeric.

Curcuminoids are polyphenolic pigments found in turmeric. Major curcuminoids derived from turmeric include, for example, curcumin, curcumene, demethoxycurcumin, and bisdemethoxycurcumin.

Curcumin, also referred to as (1E,6E)-1,7-Bis(4-hydroxy-3-methoxyphenyl)-1,6-heptadiene-3,5-dione, makes up about 70-75% of the total curcuminoids in turmeric, demethoxycurcumin about 10-20%, and bisdemethoxycurcumin generally less than about 5%. Although the present disclosure describes combinations and formulations of curcumin, it is contemplated that suitable analogues or derivatives, and suitable salts, hydrates, solvates, or prodrugs thereof may be useful in the combinations and formulations. Curcumin may be produced or derived by Curcuma longa, which typically matures in a period of eight to ten months.

Essential oils found in turmeric include, for example, turmerone, germacrone, atlantone, curlone, curdione, zedeorone, and zingiberene, or analogues or derivatives thereof. In some embodiments, the essential oils include aromatic analogues of any one of turmerone, germacrone, atlantone, curlone, curdione, zedeorone, and zingiberene. In some embodiments, for example, turmerone includes aromatic turmerone (ar-turmerone), α-turmerone, or β-turmerone, or a combination thereof.

Accordingly, in any of the embodiments provided herein, the beverage composition includes any one or more of a compound isolated from turmeric, including a curcuminoid, such as curcumin, curcumene, demethoxycurcumin, or bisdemethoxycurcumin, or an essential oil, such as turmerone, germacrone, atlantone, curlone, curdione, zedeorone, and zingiberene.

In some embodiments, the turmeric or a component or compound derived from turmeric is obtained from Curcuma longa or from a subspecies thereof. In some embodiments, the turmeric or a component or compound derived from turmeric is obtained from the roots or rhizomes of Curcuma longa or a subspecies thereof.

In some embodiments, the turmeric or a component or compound derived from turmeric is obtained as a fresh turmeric rhizome. In some embodiments, the turmeric or component or compound derived from turmeric is a commercial grade purified compound, such as a powder or paste. Component parts of turmeric may be lost during processing to powders or pasts, including the loss of or lower quality oils and gaseous components. Thus, in some embodiments, fresh turmeric is used. However, in some embodiments, processed turmeric or a component or compound derived from turmeric is used.

In some embodiments, the turmeric or a component or compound derived from turmeric is present in the beverage composition an amount of greater than 0.001, 0.005, 0.01, 0.05, 0.1, 0.5, 1, 1.5, 2, 2.5, 3, 3.5, 4, 4.5, 5, 6, 7, 8, 9, 10, 15 or 20 mg/ml, or in an amount within a range defined by any two of the aforementioned values. In some embodiments, the turmeric or component or compound derived from turmeric is present in an amount of 10 mg/ml. In some embodiments, the beverage composition is made as a stock solution, from which a drinkable beverage is made. For example, a stock solution may be referred to as a 100% solution, and a drinkable beverage may be in an amount of 1%, 5%, 10%, 20%, 30%, 40%, 50%, 60%, 70%, 80%, 90%, or 99% of the stock solution, such that the drinkable beverage is diluted from the stock solution. In instances where the drinkable beverage is diluted, the amount of turmeric or component or compound derived from turmeric is likewise diluted. In some embodiments, the drinkable beverage is the stock solution, such that no dilution takes place.

As used herein quercetin is a flavonol compound that can be found at least in the following fruits and vegetables: capers, lovage, dock like sorrel, radish leaves, carob fiber, dill, cilantro, Hungarian wax pepper, fennel leaves, red onion, radicchio, watercress, buckwheat, kale, chokeberry, cranberry, lingonberry, black plums, cow peas, sweet potato, blueberry, sea buckthorn berry, rowanberry, crowberry, prickly pear cactus fruits, red apples, broccoli, bilberry, tomatoes, grapes, black tea, and green tea. In some embodiments, pure quercetin may be extracted from the flowering genus of plants, Uncaria. In some embodiments, quercetin is derived from red grape skins. In some embodiments, quercetin is available in wines, including in red wine.

In some embodiments, quercetin can refer to aglycone quercetin (or quercetin aglycone). Aglycone quercetin can refer to the quercetin backbone without any bound glucosyl or polysaccharide groups. Aglycone quercetin can also be referred to as 2-(3,4-dihydroxyphenyl)-3,5,7-trihydroxy-4H-chromen-4-one. Aglycone quercetin can also be referred to as one or more of sophoretin, meletin, quercetine, xanthaurine, quercetol, quertine, and/or flavin meletin.

In some embodiments, quercetin refers to quercetin glucosides. Naturally occurring forms of quercetin can include quercetin glycosides. Quercetin glycosides can include rutin, (for example, rutoside, sophorin, and quercetin-3-O-rutinoside). Quercetin glycoside can also include quercitrin, which is a 3-O-a-L-rhamnoside. Quercetin glycoside can also include guaijaverin, which is a 3-O-arabinoside. Quercetin glycoside can also include hyperoside, which is a 3-O-galactoside. Quercetin glycoside can also include isoquercetin, which is a 3-O-glucoside. Quercetin glycoside can also include spiraeoside, which is a 4′-O-glucoside. Quercetin glycoside can also include miquelianin, which is a quercetin 3-O—B-d-glucuronopyranoside.

In some embodiments, quercetin comprises any aglycone quercetin, any quercetin glycoside, and/or any quercetin derivative. Quercetin can be derived from any appropriate plant-based source. Quercetin can comprise any plant-based extract that is enriched in any aglycone quercetin, any quercetin glycoside, and/or any quercetin derivative. Quercetin can be extracted, isolated, and/or enriched by any appropriate methods as known in the art. Quercetin can comprise a mixture further comprising one or more of polyphenols, flavonoids, and/or flavonols.

Quercetin is a powerful antioxidant that provides numerous health benefits to humans that ingest the compound, including improving athletic performance, improving cardiovascular health, aiding in immune response, reducing blood pressure, and reducing LDL cholesterol. In some embodiments, quercetin is provided in the beverage composition and increases bioavailability and/or is used as a bioenhancer.

In some embodiments, the quercetin or an analogue or derivative thereof is present in the beverage composition in an amount of greater than 0.001, 0.005, 0.01, 0.05, 0.1, 0.5, 1, 1.5, 2, 2.5, 3, 3.5, 4, 4.5, 5, 6, 7, 8, 9, 10, 15 or 20 mg/ml, or in an amount within a range defined by any two of the aforementioned values. In some embodiments, the quercetin or an analogue or derivative thereof is present in an amount of 10 mg/ml. In some embodiments, the beverage composition is made as a stock solution, from which a drinkable beverage is made. For example, a stock solution may be referred to as a 100% solution, and a drinkable beverage may be in an amount of 1%, 5%, 10%, 20%, 30%, 40%, 50%, 60%, 70%, 80%, 90%, or 99% of the stock solution, such that the drinkable beverage is diluted from the stock solution. In instances where the drinkable beverage is diluted, the amount of quercetin or an analogue or derivative thereof is likewise diluted. In some embodiments, the drinkable beverage is the stock solution, such that no dilution takes place.

Resveratrol is a stilbenoid, and may include trans-resveratrol, cis-resveratrol, or dihydro-resveratrol. Resveratrol is produced by knotweeds, pine trees, grape vines, peanut plants, cocoa bushes, blueberries, raspberries, mulberries, cranberries, and bilberries. A common source of dietary resveratrol is red wine. In particular, wines made from grapes of Pinot noir and St. Laurent exhibit high levels of resveratrol.

In some embodiments, the resveratrol or an analogue or derivative thereof is present in the beverage composition in an amount of greater than 0.001, 0.005, 0.01, 0.05, 0.1, 0.5, 1, 1.5, 2, 2.5, 3, 3.5, 4, 4.5, 5, 6, 7, 8, 9, 10, 15 or 20 mg/ml, or in an amount within a range defined by any two of the aforementioned values. In some embodiments, the resveratrol or an analogue or derivative thereof is present in an amount of 10 mg/ml. In some embodiments, the beverage composition is made as a stock solution, from which a drinkable beverage is made. For example, a stock solution may be referred to as a 100% solution, and a drinkable beverage may be in an amount of 1%, 5%, 10%, 20%, 30%, 40%, 50%, 60%, 70%, 80%, 90%, or 99% of the stock solution, such that the drinkable beverage is diluted from the stock solution. In instances where the drinkable beverage is diluted, the amount of resveratrol or an analogue or derivative thereof is likewise diluted. In some embodiments, the drinkable beverage is the stock solution, such that no dilution takes place.

The source of any one of curcumin, quercetin, resveratrol, or a combination thereof that is added to the beverage compositions described herein may be a plant-based source, as described, or may be an artificial source, such as from chemical synthesis of the compound. Furthermore, the source of any one of curcumin, quercetin, resveratrol, or a combination thereof that is added to the beverage compositions may be a consumer available source, such as a processed source of high purity compound.

In some embodiments, the beverage composition is an alcoholic beverage. Examples of alcoholic beverages include beer, ale, spirit, wine (such as red wine, white wine, rosé wine, fruit wine, mead, or starch wine), sherry, brandy, liqueurs, port, vodka, gin, whisky, scotch, absinthe, cognac, tequila, rum, ouzo, sake, or champagne, or combinations thereof. In some embodiments, the alcoholic beverage is distilled or non-distilled. In some embodiments, the alcoholic beverage is strained, filtered, sonicated, or otherwise purified. In some embodiments, the alcoholic beverage includes bioavailability enhancers (or bioenhancer), sweeteners, flavors, spices, coloring agents, carbonation, minerals, juices, or other component parts.

As used herein, the term “bioenhancer” has its ordinary meaning as understood in light of the specification, and refers to an agent that increases bioavailability of other substances. As used herein “bioavailability” has its ordinary meaning as understood in light of the specification, and includes, generally, the degree to which a substance becomes available to a subject following ingestion, administration, or exposure. In some embodiments, bioenhancers include any agent that is capable of increasing an amount of turmeric uptake by the body upon ingestion of the beverage compositions. In some embodiments, the bioenhancer is selected from the group consisting of a charge masking compound, a solubilizing compound, a reducing compound, a stabilizing compound, a lubricating compound, an enteric coating, and a permeability enhancing compound.

Turmeric's pharmacological efficacy is profoundly affected by its bioavailability/absorption. Bioavailability is related to how a nutrient detaches from food, is absorbed by the intestines, enters the bloodstream, and reaches the target cells. Turmeric's low bioavailability is attributed to poor absorption, active metabolism, and rapid excretion from the system. Turmeric is more bioavailable than curcumin due to the presence of other compounds, including turmerones, a lipophilic component. In some embodiments, piperine is a bioavailability enhancer and can be used with or without lipids. The chemical interactions of alcohol and water solutions can be used to determine the various mixtures to increase bioavailability and nutrient delivery compounds amongst turmeric, piperine, lipids, including, but not limited to the following: ingestible essential oils generally regarded as safe, honey, vegetable glycerin, omega-3 fish oil, flax seed oil, olive oil, canola oil, soybean oil, sunflower oil, a terpene, a cannabinoid, such as cannabidiol, resveratrol, quercetin, or helichrysum italicum oil (curry plant-immortelle), or combinations thereof, which may be included in the beverage compositions described herein.

In some embodiments, the bioenhancer includes quercetin, resveratrol, silibinin, curcumin, piperine, gingerol, allicin, glycyrrhizin, genistein, sinomenine, Stevia rebaudiana, Aloe vera, lysergol, Carum carvi, niaziridin, capsaicin, naringin, Zingiber officinalte, Ammannia multiflora, capul, cow urine distillate, essential oils, honey vegetable glycerin, omega-3 fish oil, flax seed oil, olive oil, canola oil, soybean oil, sunflower oil, a cannabinoid, such as cannabidiol, a terpene, or helichrysum italicum oil, or any combination thereof. Bioavailability enhancers may be added in an amount of about 0.001% w/v to about 25% w/v based on the total weight of the beverage composition, such as 0.001, 0.005, 0.01, 0.05, 0.1, 0.5, 1, 2, 3, 4, 5, 6, 7, 8, 9, 10, 15, 20, or 25% w/v based on the total weight of the beverage composition, or in an amount within a range defined by any two of the aforementioned values.

As used herein, the term “cannabinoid” has its ordinary meaning as understood in light of the specification, and refers to a compound within the class that acts upon cannabinoid receptors (such as on the endocannabinoid system) in cells. A cannabinoid can include a synthetic cannabinoid, a phytocannabinoid, or an endocannabinoid. In some embodiments, a cannabinoid includes cannabidiols (including cannabidiol, cannabidiolic acid, cannabidiol monomethylether, cannabidiorcol, cannabidivarin, or cannabidivarinic acid), tetrahydrocannabinols (including delta-9-tetrahydrocannabinol, delta-9-cis-tetrahydrocannabinol, delta-9-tetrahydrocannabinol-C4, delta-9-tetrahydrocannabinolic acid A, delta-9-tetrahydrocannabinolic acid B, delta-9-tetrahydrocannabinolic acid C4, delta-9-tetrahydrocannabiorcol, delta-9-tetrahydrocannabiocolic acid, delta-9-tetrahydrocannabivarin, delta-9-tetrahydrocannabivarinic acid, tryhydroxy-delta-9-tetrahydrocannabinol, delta-8-tetrahydrocannabinol, or delta-8-tetrahydrocannabinolic acid), cannabichromenes (including cannabichromene, cannabichromenenic acid, cannabichromevarin, cannabichromenvarinic acid), cannabigerols (including cannabigerol, cannabigerol monomethylether, cannabigerolic acid, cannabigerolic acid monomethylether, cannabinerolic acid, cannabigerovarin, or cannabigerovarinic acid), cannabielsoins (including cannabielsoin, cannabielsoic acid A, or cannabielsoic acid B), cannabinols or cannabinodiols (includiong cannabinodiol, cannabinodivarin, cannabinol, cannabinol methylether, cannabinol-C2, cannabinol-C4, cannabinolic acid, cannabiorcool, or cannabivarin), cannabitriols (including cannabitriol, cannabitriolvarin, 10-ethoxy-9-hydroxy-delta-6a-tetrahydrocannabinol, or 8,9-dihydroxy-delta-6a-tetrayhydrocannabinol), cannabicyclols, 10-oxo-delta-6a-tetrahydrocannabinol, cannabichromanon, cannabifuran, cannabiglendol, cannabiripsol, cannbicitran, dehydrocannabifuran, cannabicitran, or 3,4,5,6-tetrahydro-7-hydroxy-alpha-alpha-trimethyl-9-n-propyl-2,6-methano-2H-1-benzoxicin-5-methanol, or any analogue or derivative thereof. A cannabinoid may be included in the compositions in an amount of about 0.001% w/v to about 25% w/v based on the total weight of the beverage composition, such as 0.001, 0.005, 0.01, 0.05, 0.1, 0.5, 1, 2, 3, 4, 5, 6, 7, 8, 9, 10, 15, 20, or 25% w/v based on the total weight of the beverage composition, or in an amount within a range defined by any two of the aforementioned values.

As used herein, the term “terpene” has its ordinary meaning as understood in light of the specification, and refers to an organic hydrocarbon compounds containing an isoprene. A terpene may be cyclic, acyclic, saturated, unsaturated, oxygenated, non-oxygenated, a terpenoid, a monomer terpene (monoterpene), or a polyterpene (such as a sesquiterpene, diterpene, or etc.), or an analogue or derivative thereof. In some embodiments, the terpene is myrcene, limonene, linalool, caryphyllene, alpha-pinene, beta-pinene, alpha-bisabolol, eucalyptol, trans-nerolido, humulene, delta 3 carene, camphene, borneol, terpineol, valencene, or geraniol.

In some embodiments, bioavailability of compounds in the beverage compositions, such as bioavailability of turmeric or compounds derived therefrom is increased due to increased absorption or turmeric or compounds derived therefrom. In some embodiments, absorption of turmeric or compounds derived therefrom is increased due to the presence of absorption increasing agents. In some embodiments, absorption increasing agents deliver phosphatidylcholine. In some embodiments, absorption increasing agents include, for example, a lecithin or a lipid.

In some embodiments, the bioavailability of turmeric or compounds derived therefrom is enhanced by including in the beverage composition a lipid. Lipids, including fats or oils, favorably affect at least four major process of turmeric delivery within the body, including solubility, dispersion, digestion, and absorption.

An increase in turmeric or compounds derived therefrom may be increased in an amount ranging from about 10% to about 500%. Thus, in some embodiments, an increase in an amount of total turmeric intake (or intake of a component or compound derived from turmeric) is in an amount of 10%, 20%, 30%, 40%, 50%, 60%, 70%, 80%, 90%, 100%, 110%, 120%, 130%, 140%, 150%, 160%, 170%, 180%, 190%, 200%, 220%, 240%, 260%, 280%, 300%, 350%, 400%, 450%, or 500%, or an increase in an amount within a range defined by any two of the aforementioned values.

In some embodiments, a sweetener may include, for example, one or more of agave inulin, agave nectar, agave syrup, amazake, brazzein, brown rice syrup, coconut crystals, coconut sugars, coconut syrup, date sugar, fructans (also referred to as inulin fiber, fructo-oligosaccharides, or oligo-fructose), green stevia powder, Stevia rebaudiana, rebaudioside A, rebaudioside B, rebaudioside C, rebaudioside D, rebaudioside E, rebaudioside F, rebaudioside I, rebaudioside H, rebaudioside L, rebaudioside K, rebaudioside J, rebaudioside N, rebaudioside O, rebaudioside M and other sweet stevia-based glycosides, stevioside, stevioside extracts, honey, Jerusalem artichoke syrup, licorice root, luo han guo (fruit, powder, or extracts), lucuma (fruit, powder, or extracts), maple sap (including, for example, sap extracted from Acer saccharum, Acer nigrum, Acer rubrum, Acer saccharinum, Acer platanoides, Acer negundo, Acer macrophyllum, Acer grandidentatum, Acer glabrum, Acer mono), maple syrup, maple sugar, walnut sap (including, for example, sap extracted from Juglans cinerea, Juglans nigra, Juglans ailatifolia, Juglans regia), birch sap (including, for example, sap extracted from Betula papyrifera, Betula alleghaniensis, Betula lenta, Betula nigra, Betula populifolia, Betula pendula), sycamore sap (such as, for example, sap extracted from Platanus occidentalis), ironwood sap (such as, for example, sap extracted from Ostrya virginiana), mascobado, molasses (such as, for example, blackstrap molasses), molasses sugar, monatin, monellin, cane sugar (also referred to as natural sugar, unrefined cane sugar, or sucrose), palm sugar, panocha, piloncillo, rapadura, raw sugar, rice syrup, sorghum, sorghum syrup, cassava syrup (also referred to as tapioca syrup), thaumatin, yacon root, malt syrup, barley malt syrup, barley malt powder, beet sugar, cane sugar, crystalline juice crystals, caramel, carbitol, carob syrup, castor sugar, hydrogenated starch hydrolates, hydrolyzed can juice, hydrolyzed starch, invert sugar, anethole, arabinogalactan, arrope, syrup, P-4000, acesulfame potassium (also referred to as acesulfame K or ace-K), alitame (also referred to as aclame), advantame, aspartame, baiyunoside, neotame, benzamide derivatives, bernadame, canderel, carrelame and other guanidine-based sweeteners, vegetable fiber, corn sugar, coupling sugars, curculin, cyclamates, cyclocarioside I, demerara, dextran, dextrin, diastatic malt, dulcin, sucrol, valzin, dulcoside A, dulcoside B, emulin, enoxolone, maltodextrin, saccharin, estragole, ethyl maltol, glucin, gluconic acid, glucono-lactone, glucosamine, glucoronic acid, glycerol, glycine, glycyphillin, glycyrrhizin, golden sugar, yellow sugar, golden syrup, granulated sugar, gynostemma, hernandulcin, isomerized liquid sugars, jallab, chicory root dietary fiber, kynurenine derivatives (including N′-formyl-kynurenine, N′-acetyl-kynurenine, 6-chloro-kynurenine), galactitol, litesse, ligicane, lycasin, lugduname, guanidine, falernum, mabinlin I, mabinlin II, maltol, maltisorb, maltodextrin, maltotriol, mannosamine, miraculin, mizuame, mogrosides (including, for example, mogroside I (including mogrosides I_{A} and I_{E}), mogroside II (including mogrosides II_{A}, II_{A1}, II_{A2}, II_{B}, and II_{E}), mogroside III (including mogroside III_{A2}, III_{E}), mogroside IV (including mogrosides IV_{A} and IV_{E}), mogroside V, and mogroside VI), 7-oxomogrosides (including, for example, 7-oxomogroside II_{E} and 7-oxomogroside V), 11-deoxymogrosides (including, for example, 11-deoxymogrosides III and V), 11-oxomogrosides (including, for example, 11-oxomogrosides I_{A}, III_{E}, IV, IV_{A}, IV_{E}, V, and VI), siamenoside, siamenoside I, isomogroside, isomogroside V, mogrol, 11-oxomogrol, neomogroside, mukurozioside, nano sugar, naringin dihydrochalcone, neohesperidine dihydrochalcone, nib sugar, nigero-oligosaccharide, norbu, orgeat syrup, osladin, pekmez, pentadin, periandrin I, perillaldehyde, perillartine, petphyllum, phenylalanine, phlomisoside I, phlorodizin, phyllodulcin, polyglycitol syrups, polypodoside A, pterocaryoside A, pterocaryoside B, rebiana, refiners syrup, rub syrup, rubusoside, selligueain A, shugr, siamenoside I, siraitia grosvenorii, soybean oligosaccharide, Splenda, SRI oxime V, steviol glycoside, steviolbioside, stevioside, strogins 1, 2, and 4, sucronic acid, sucrononate, sugar, suosan, phloridzin, superaspartame, tetrasaccharide, threitol, treacle, trilobtain, tryptophan and derivatives (6-trifluoromethyl-tryptophan, 6-chloro-D-tryptophan), vanilla sugar, volemitol, birch syrup, aspartame-acesulfame, assugrin, and combinations or blends of any two or more thereof.

Sweeteners may be added in an amount of about 0.001% w/v to about 25% w/v based on the total weight of the beverage composition, such as 0.001, 0.005, 0.01, 0.05, 0.1, 0.5, 1, 2, 3, 4, 5, 6, 7, 8, 9, 10, 15, 20, or 25% w/v based on the total weight of the beverage composition, or in an amount within a range defined by any two of the aforementioned values.

In some embodiments, the flavors include, for example, one or more of apple flavors, apricot flavors, aromatic bitters flavors, banana flavors, berry flavors (including blackberry flavors, blueberry flavors, celery flavors, cherry flavors, coffee flavors, cranberry flavors, strawberry flavors, raspberry flavors, and juniper berry flavors), brandy flavors, cachaca flavors, carrot flavors, cherry flavors, chocolate flavors, cinnamon flavors, citrus flavors (including lemon flavors, lime flavors, orange flavors, grapefruit flavors, and tangerine flavors), coconut flavors, cola flavors, cooling agents (e.g., menthol), gin flavors, ginger flavors, licorice flavors, hot flavors (e.g., Heat), milk flavors, mint flavors, nut flavors (including almond flavors, hazelnut flavors, macadamia nut flavors, peanut flavors, pecan flavors, pistachio flavors, and walnut flavors), peach flavors, pear flavors, pepper flavors, pineapple flavors, plum flavors, quinine flavors, rum flavors (including white rum flavors and dark rum flavors), sangria flavors, shellfish flavors (including clam flavors), tea flavors (including black tea flavors and green tea flavors), tequila flavors, tomato flavors, top note flavors, tropical flavors, vanilla flavors, vermouth flavors (including dry vermouth flavors and sweet vermouth flavors), whiskey flavors (including bourbon whiskey flavors, Irish whiskey flavors, rye whiskey flavors, Scotch whisky flavors, and Canadian whiskey flavors), and combinations thereof.

Flavors may be added in an amount of about 0.1% w/v to about 10% w/v based on the total weight of the beverage composition, such as 0.1, 0.2, 0.3, 0.4, 0.5, 1, 2, 3, 4, 5, 6, 7, 8, 9, or 10% w/v based on the total weight of the beverage composition, or in an amount within a range defined by any two of the aforementioned values.

In some embodiments, the spices include, for example, nutmeg, allspice, pepper, black pepper, chive, oregano, cilantro, cinnamon, basil, bay leaves, cloves, coriander, cumin, fennel, garlic, ginger, juniper, mace, marjoram, mint, onion, paprika, parsley, rosemary, saffron, caraway seed, celery seed, parsley, tarragon, thyme, mustard seed, anise seed, poppy seed, lemongrass, star anise, turmeric, peppercorn, savory, achiote seed, epazote, sage, vanilla bean, and combinations thereof.

Spices may be added in an amount of about 0.001% w/v to about 10% w/v based on the total weight of the beverage composition, such as 0.001, 0.005, 0.01, 0.05, 0.1, 0.2, 0.3, 0.4, 0.5, 1, 2, 3, 4, 5, 6, 7, 8, 9, or 10% w/v based on the total weight of the beverage composition, or in an amount within a range defined by any two of the aforementioned values.

In some embodiments, the coloring agents include, for example, one or more of pigments, natural food colors and dyes suitable for food, drug and cosmetic applications, including, for example, FD&C blue #1, FD&C blue #2, FD&C green #3, FD&C red #3, FD&C red #40, FD&C yellow #5 and FD&C yellow #6, tartrazine (E102), quinoline yellow (E104), sunset yellow (E110), ponceau (E124), erythrosine (E127), patent blue V (E131), titanium dioxide (E171), aluminum (E173), silver (E174), gold (E175), pigment rubine/lithol rubine BK (E180), calcium carbonate (E170), carbon black (E153), black PN/brilliant black BN (E151), green S/acid brilliant green BS (E142), annatto extract, (E160b), bixin, norbixin, astaxanthin, dehydrated beets (beet powder), beetroot red/betanin (E162), ultramarine blue, caramel color (E150a), canthaxanthin (E161g), cryptoxanthin (E161c), rubixanthin (E161d), violanxanthin (E161e), rhodoxanthin (E161), caramel (E150(a-d)), β-apo-8′-carotenal (E60e), β-carotene (E60a), alpha carotene, gamma carotene, ethyl ester of beta-apo-8 carotenal (E160), flavoxanthin (E161a), lutein (E161b), cochineal extract (E120); carmine (E132), carmoisine/azorubine (E122), sodium copper chlorophyllin (E141), chlorophyll (E140), toasted partially defatted cooked cottonseed flour, ferrous gluconate, ferrous lactate, grape color extract, grape skin extract (enocianina), anthocyanins (E163), haematococcus algae meal, synthetic iron oxide, iron oxides and hydroxides (E172), fruit juice, vegetable juice, dried algae meal, tagetes (Aztec marigold) meal and extract, carrot oil, corn endosperm oil, paprika, paprika oleoresin, phaffia yeast, riboflavin (E101), saffron, titanium dioxide, turmeric (E100), turmeric oleoresin, amaranth (E123), capsanthin/capsorbin (E160c), lycopene (E160d), and combinations thereof. In some embodiments, the coloring agent is used in an amount to produce a desired color for the composition.

Coloring agents may be added in an amount of about 0.001% w/v to about 10% w/v based on the total weight of the beverage composition, such as 0.001, 0.005, 0.01, 0.05, 0.1, 1, 2, 3, 4, 5, 6, 7, 8, 9 or 10% w/v based on the total weight of the beverage composition, or in an amount within a range defined by any two of the aforementioned values.

In some embodiments, the beverage compositions are carbonated or non-carbonated beverages. A carbonated beverage may be carbonated with the addition of carbon dioxide.

In some embodiments, the beverage compositions include juices, such as fruit juices, berry, or vegetable juices, including, for example, citrus juices, such as lemon, lime, orange, tangerine, or grapefruit juices. Juices may be added in an amount of about 0.1% w/v to about 10% w/v based on the total weight of the beverage composition, such as 0.1, 0.2, 0.3, 0.4, 0.5, 1, 2, 3, 4, 5, 6, 7, 8, 9, or 10% w/v based on the total weight of the beverage composition, or in an amount within a range defined by any two of the aforementioned values.

In some embodiments, the beverage compositions include additional components, such as vitamins, minerals, salts, preservatives, antioxidants, or other components suitable for beverage compositions.

### Methods of Manufacture

Some embodiments provided herein relate to methods of manufacturing the beverage compositions as described herein. In some embodiments, the methods include providing an amount of turmeric, including turmeric derived compounds. In some embodiments, turmeric or a component or compound derived from turmeric is provided as a commercially available turmeric or a component or compound derived from turmeric, such as a processed powder or paste. In some embodiments, the turmeric is provided as fresh turmeric, for example, as a turmeric rhizome. In some embodiments, the methods include extracting compounds from turmeric. In some embodiments, extraction is a physical or chemical process. In some embodiments, extraction includes grinding, milling, crunching, cutting, chopping, grating, pulverizing, blending, mixing, pressing, crushing, pressurizing, boiling, steaming, or a combination thereof or otherwise processing the rhizome to extract compounds from turmeric. In some embodiments, extraction provides an amount of turmeric or compounds derived from turmeric for addition to a beverage composition. In some embodiments, the compounds derived from turmeric using the extraction methods described herein include curcuminoids, such as curcumin, curcumene, demethoxycurcumin, or bisdemethoxycurcumin, or an essential oil, such as turmerone, germacrone, atlantone, curlone, curdione, zedeorone, or zingiberene, or any combination thereof, or any of the more than 235 compounds from turmeric.

In some embodiments, the methods include adding an amount of turmeric or a component or compound derived from turmeric to a beverage composition. In some embodiments, the beverage composition is an alcoholic beverage. Turmeric and compounds derived from turmeric generally have a low solubility in aqueous solution, and are thus of low bioavailability. However, the solubility of turmeric and compounds derived from turmeric increases in alcohol. In some embodiments, alcohol is used to extract one or more compounds derived from turmeric. In some embodiments, the turmeric or compounds derived from turmeric are added to an alcoholic beverage in an amount of greater than 0.001, 0.005, 0.01, 0.05, 0.1, 0.5, 1, 1.5, 2, 2.5, 3, 3.5, 4, 4.5, 5, 6, 7, 8, 9, 10, 15 or 20 mg/ml, or in an amount within a range defined by any two of the aforementioned values. In some embodiments, the turmeric or a component or compound derived from turmeric is present in an amount of 10 mg/ml.

In some embodiments, a stock solution of 100% alcoholic beverage is used to prepare a drinkable alcoholic beverage by diluting the stock solution to the desired proof. For example, the stock solution may be used to prepare a solution of greater than 1% (2 proof), 5% (10 proof), 10% (20 proof), 20% (40 proof), 30% (60 proof), 40% (80 proof), 50% (100 proof), 60% (120 proof), 70% (140 proof), 80% (160 proof), 90% (180 proof), or 99% (198 proof) drinkable alcoholic beverage, or an amount within a range defined by any two of the aforementioned values.

By way of example, where a stock solution of 100% alcohol is prepared having 10 mg/ml of compounds derived from turmeric, an alcoholic beverage of 1% includes 0.1 mg/ml of compounds derived from turmeric, 5% includes 0.5 mg/ml, 10% includes 1 mg/ml, 20% includes 2 mg/ml, 30% includes 3 mg/ml, 40% includes 4 mg/ml, 50% includes 5 mg/ml, 60% includes 6 mg/ml, 70% includes 7 mg/ml, 80% includes 8 mg/ml, 90% includes 9 mg/ml, and 99% includes 9.9 mg/ml of compounds derived from turmeric.

In some embodiments, the solubility of turmeric and compounds derived from turmeric can be increased by adding solubility increasing compounds to the beverage composition. A solubility increasing compound is a compound that increases the solubility of turmeric or compounds derived from turmeric in the beverage composition, and may include, for example, alkaloid compounds. Alkaloid compounds that may be used to increase solubility of the turmeric or compounds derived from turmeric include, for example, piperine. Piperine is an alkaloid that is partially responsible for the pungency of black pepper. It is also referred to as black pepper extract. Piperine is believed to have medicinal effects, including modulating efflux mechanisms, modulating metabolic enzymes, and stimulating thermogenesis, the metabolic process that generates energy at the cellular level. Thermogenesis has been identified as playing an integral role in utilizing the daily food and nutrients that the human body consumes. It sets in motion the mechanisms that lead to digestion and subsequent gastrointestinal absorption.

In some embodiments, the beverage compositions are prepared at a pH ranging from about 2 to about 9, including a pH of 2, 3, 4, 5, 6, 7, 8, or 9, or any pH value within a range defined by any two of the aforementioned values. Curcumin and other compounds found in turmeric degenerates or degrade more quickly in a solution whose pH is alkaline. Thus, in some embodiments, the beverage is maintained in a solution with a pH of less than 7. In some embodiments, the beverage is maintained in a solution with a pH of less than 6. In some embodiments, a pH is achieved with the addition of pH adjusting components, which may include, for example, carbon dioxide, citrus juice (citric acid), vinegar, or other digestible acids. In some embodiments, the beverage shelf life is enhanced and increased by such addition of acids to maintain the pH of less than 7.

In some embodiments, the alcoholic beverages have increased quantities of turmeric or compounds derived from turmeric compared to an amount of turmeric or compounds derived from turmeric in non-alcoholic beverages due to the increased solubility of turmeric or compounds derived from turmeric in the alcoholic beverage. Accordingly, a person consuming the alcoholic beverages described herein can consume lower quantities of alcohol to obtain high quantities of turmeric or compounds derived from turmeric due to the increased bioavailable amounts of turmeric or compounds derived from turmeric in the alcoholic beverages described herein. Many uses of turmeric occur by belief in the benefits of the compounds derived from turmeric as assimilated from ingestion of the compounds and increasing the bioavailability of turmeric or compounds derived therefrom decreases the quantity required to achieve consumption parameters. This can further decrease the quantity of turmeric or compounds derived therefrom needed to meet commercial expectations of efficacy. Turmeric rhizomes contain many compounds that have not been thoroughly studied and many are believed to be interdependent for the best benefit. There might be a need to suppress bioavailability for some uses and this disclosure provides the possibility by removing certain compounds, such as turmerone, or removing such concentration of compounds to accommodate other active desired compounds.

In some embodiments, the methods further include mixing one or more alcoholic beverage that includes turmeric or compounds derived from turmeric with one or more other beverages that may or may not include turmeric or a component or compound derived from turmeric. In some embodiments, the mixed drinks include cocktails, including, for example, Ruby Relaxers, Pina Colada, Miami Vice, Mai Tai, Grateful Dead, Tokyo Tea, Long Island Tea, Surfer on Acid, Blue Hawaiian, Caribou Lou, Mojito, Jungle Juice, Strawberry Daiquiri, Scooby Snack, Lava Flow, Mint Julep, Southern Comfort Manhattan, Regular Manhattan, B-52 Bomber, Gimlet, Cucumber-Lemonade Chiller, Cosmopolitan, Lemon Drop, Apple Martini, Bloody Mary, Cape Cod, Salty Dog, Screwdriver, Sea Breeze, White Russian, or Margarita.

### EXAMPLES

Some aspects of the embodiments discussed above are disclosed in further detail in the following examples, which are not in any way intended to limit the scope of the present disclosure. Those in the art will appreciate that many other embodiments also fall within the scope of the disclosure, as it is described herein above and in the claims.

### Example 1

### Preparation of Beverage Composition

An alcoholic beverage was prepared having turmeric and compounds derived from turmeric. A turmeric rhizome was obtained, and crushed to extract compounds derived from turmeric. To an alcoholic beverage was added curcumin and turmerone oil derived from the turmeric rhizome. Also added was peppercorn, lime juice or orange juice, and honey.

The alcoholic beverage exhibited elevated quantities of curcumin and turmerone oil than would have otherwise been achieved, for example, in a non-alcoholic beverage. The increased quantities of curcumin and turmerone resulted in increased bioavailability of curcumin and turmerone in the alcoholic beverage. Specifically, subject that ingest the alcoholic beverage exhibit elevated quantities of total turmeric intake, including increased quantities of total curcumin and total turmerone oil that would have otherwise been achieved.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into sub-ranges as discussed above. Finally, as will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A beverage composition, comprising:
one or more compounds derived from turmeric;
an alkaloid;
citric juice; and
a sweetener.

2. The beverage composition of claim 1, wherein the beverage is an alcoholic beverage.

3. The beverage composition of claim 2, wherein the alcoholic beverage is beer, ale, spirit, wine, sherry, brandy, liqueurs, port, vodka, gin, whisky, scotch, absinthe, cognac, tequila, rum, ouzo, sake, or champagne, or combinations thereof.

4. The beverage composition of claim 1, wherein the one or more compounds derived from turmeric comprise curcumin, curcumene, demethoxycurcumin, bisdemethoxycurcumin, turmerone, germacrone, atlantone, curlone, curdione, zedeorone, or zingiberene, or a combination thereof.

5. The beverage composition of claim 1, wherein the one or more compounds derived from turmeric are derived from a turmeric rhizome.

6. The beverage composition of claim 1, wherein the alkaloid is piperine.

7. The beverage composition of claim 6, wherein the piperine is derived from peppercorn.

8. The beverage composition of claim 1, wherein the citric juice is lime juice, lemon juice, orange juice, tangerine juice, grapefruit juice, or a combination thereof.

9. The beverage composition of claim 1, wherein the sweetener comprises honey.

10. The beverage composition of claim 1, wherein the one or more compounds derived from turmeric is present in an amount of about 0.001 mg/ml to about 10 mg/ml, the alkaloid is present in an amount of about 0.001% w/v to about 10% w/v, the citric juice is present in an amount of 0.1% w/v to about 10% w/v, and the sweetener is present in an amount of 0.001% w/v to about 25% w/v.

11. The beverage composition of claim 1, wherein the composition comprises curcumin present in an amount of about 0.001 mg/ml to about 10 mg/ml, turmerone present in an amount of about 0.001 mg/ml to about 10 mg/ml, peppercorn present in an amount of about 0.001% w/v to about 10% w/v, lime or orange juice present in an amount of about 0.1% w/v to about 10% w/v, and honey present in an amount of 0.001% w/v to about 25% w/v.

12. The beverage composition of claim 1, further comprising a cannabinoid or a terpene.

13. The beverage composition of claim 1, further comprising cannabidiol.

14. A method of making the beverage composition of claim 1, the method comprising:
providing a turmeric rhizome;
extracting one or more compounds from the turmeric rhizome; and
adding the extracted one or more compounds from the turmeric rhizome to a solution.

15. The method of claim 14, wherein the solution is an alcohol solution.

16. The method of claim 14, further comprising adding an alkaloid.

17. The method of claim 14, further comprising maintaining a pH of the solution at a pH ranging from about 2 to about 7.

18. A method of increasing bioavailability of turmeric or a component or compound derived therefrom, comprising:
mixing turmeric or a component or compound derived therefrom in a solution;
mixing the solution with a bioavailability enhancing compound; and
administering the solution to a subject,
wherein intake of turmeric or a component or compound derived therefrom is increased.

19. The method of claim 18, wherein the solution is an alcohol solution.

20. The method of claim 18, further comprising increasing total turmeric or component or compound derived therefrom in the subject, wherein the subject's turmeric or component or compound derived therefrom is increased from 10% to 500%.
